(19) United States
(12) Patent Application Publication
(10) Pub. No.: US 2008/0041891 A1
(43) Pub. Date: Feb. 21, 2008

(54) BOTTLE CAP

(76) Inventor: Sarah Bradley, Toronto (CA)

Correspondence Address: DIMOCK STRATTON LLP, 20 QUEEN STREET WEST SUITE 3202, BOX 102, TORONTO, ON, M5H 3R3, US

(21) Appl. No.: 11/464,696

(22) Filed: Aug. 15, 2006

(51) Int. Cl. B67D 3/00

(52) U.S. Cl. 222/521

(57) ABSTRACT

A replacement bottle cap for commonly used beverage bottles that provides a resealable spout that dispenses liquid at a selected rate. An end-cap is slidably affixed to a cental body and comprising a spout with perforations for dispensing and regulating the flow of liquid and an internal sealing means to prevent or allow liquid to flow through the spout cap, that may be opened or closed through the movement of the end-cap along the central body into discrete, releasably fixed positions.

### FIELD OF THE INVENTION

The present invention relates to a replacement bottle cap for commonly used beverage bottles. More particularly, the present invention relates to a re-sealable flow regulated replacement bottle caps for use by infants and small children.

### BACKGROUND OF THE INVENTION

The prior art discloses a number of different types of sipping cup beverage containers having lids that are tailored for use by infants and small children.

One such container and lid device is commonly referred to as the “sipping cup” comprises a cup with a lid that has an opening with a built-in mouthpiece or spout. The cup and lid design helps prevent spills by simply providing a narrow aperture for the liquid to flow through in the event the cup falls over. However, the lid cannot be used independently of the cup. As a result, sipping cups are inconvenient because the original container cannot be used since the beverage must be transferred from the original container into the sipping cup. This is inconvenient because both the cup and lid must be transported and kept clean before being used when used outside of the home. The cup and lid combination is also inefficient because they are non-closable and, therefore, not amenable to being transported when filled with beverage.

U.S. Pat. No. 6,112,926, which is incorporated herein by reference, discloses a device that comprises a threaded bottle cap that incorporates a mouthpiece or spout intended for use as a sipping spout on common beverage bottles. This design overcomes some of the disadvantages of the sipping cup; however, it is still limited in a number of ways. In particular, the flow of liquid is only regulated by the size of the slotted aperture of the spout and it is non-closable. In order to re-close the beverage bottle, the original bottle cap must be re-used.

A number of variations of nipple adapters for use with common beverage bottles are also disclosed in the prior art. Examples include U.S. Pat. No. 5,024,341 (“Dekerle”), U.S. Pat. No. 6,354,449 (“Smith”), U.S. Pat. No. 6,666,345 (“Blanding”) and U.S. Pat. No. 6,851,565 (“Stephan”), each of which is incorporated herein by reference. Dekerle, Smith and Stephan each disclose nipple adapters that comprise and assembly of several components that include an end-piece in the form of a nipple and adapters for securing the end-piece to a standard beverage bottle. Although these devices provide a means for fitting a nipple adapter to a standard bottle, in each case the invention is directed to a means for fastening or adapting a baby bottle nipple adapter to a water bottle by way of a complex assembly of threaded adapters. In addition, none of the devices provide a means for re-sealing the bottle once the nipple adapter has been fastened. In addition, Dekerle, Smith and Stephan are specifically directed to nipple adapters and would not be amenable for use with a sipping spout. Blanding merely provides a combination molded baby bottle cap and molded water bottle cap in which soft rubber baby bottle cap is provided with a plurality of molded circular ribs that engage the interior of a molded hard plastic bottle cap. This combination provides a bottle cap having two threaded portions, one sized appropriately for affixing the cap to a baby bottle and the other sized for a standard water bottle.

U.S. Pat. No. 3,599,845 (“Miller”) discloses a combined bottle closure and dispensing cap. Miller discloses a combination cap comprising a main closure body having a dispensing neck portion and a closure cap having an aperture and a skirt portion. The skirt portion of the closure cap slidedably engages the neck portion of the closure body. The closure body is constructed out of a hard plastic and the dispensing neck portion includes a pin or stopper that snugly engages the aperture of the closure cap such that the aperture may be opened and closed through the sliding motion of the closure cap along the neck portion of the closure body. In the closure and dispensing cap disclosed by Miller the closing and dispensing apertures are one and the same and the closing means requires engagement between the dispensing aperture and a sealing plug or stopper. As a result of this configuration, a closure cap constructed according to Miller is limited to closure caps with relatively large apertures and correspondingly high flow rates of liquid through the cap when it is in the open position.

U.S. Pat. No. 5,145,094 (“Perlmutter”), which is incorporated herein by reference, also discloses a combination closure and dispensing cap in which the cap can be moved into an open and a closed position through the push-pull movement of an apertured closure body along a cap portion wherein the cap portion has a plug or stopper member that engages the aperture of the closure body to create a seal when the closure body is in the closed position. In addition, Perlmutter provides a second sealing means when the cap is in the first closed position as well as a second closed position in which provides a low friction connection between the closure body and cap member such that the closure body can be easily moved into an open position for dispending liquid. Finally, Perlmutter discloses a further embodiment in which the closure body has a closed position, an intermediate open position and an open position. In the intermediate position, the closure body is positioned such that a relatively small annular space is provided between the plug and aperture in the closure body. When in the intermediate position, a squeeze force applied to the liquid container will force a limited amount of liquid to flow or squirt through the aperture in the closure body. As with Miller, the cap disclosed in Perlmutter is limited to closure caps with relatively large apertures and correspondingly high flow rates of liquid through the cap when it is in the open position.

The closure and dispensing caps disclosed in the Miller and Perlmutter are further limited in that they are directed particularly to use with squeezable containers where the rate of flow of liquid through the aperture is not important and is primarily regulated by the degree to which the container of liquid that the caps are affixed to is compressed. Furthermore, the construction of closure and dispensing caps according to Miller and Perlmutter with restricted flow are limited by the manufacturing tolerances of commonly used plastics; therefore, cannot be constructed to provide flow rates that are substantially reduced and controlled at a consistent, low volume appropriate for infants and small children. Neither of these closure and dispensing caps are; therefore, appropriate for use by infants and small children.

### SUMMARY OF THE INVENTION

The present invention described in detail below, overcomes the limitations in the prior art by providing a closable cap for use with commonly used beverage containers such as plastic water and juice bottles in which the dispensing and closure means are separated and the dispensing means provides for a low rate of flow of liquid through the cap that is appropriate for infants and small children. The present invention has the further advantage of being simple in construction and, therefore, particularly suitable for mass production and assembly.

Given the shortcomings with prior art devices discussed above, an aspect of the present invention provides a replacement bottle cap for commonly used beverage bottles that provides a spout and dispenses liquid at a rate that is appropriate for infants and small children.

A further aspect of the present invention provides a spouted replacement bottle cap having a spout that is re-sealable.

A still a further aspect of the present invention provides a re-sealable spouted replacement bottle cap that that dispenses liquid at a flow rate appropriate for infants and small children that is of a simple construction in order to facilitate manufacturing according to current manufacturing tolerances.

The present invention is a flow regulated spout-cap for use with common beverage bottles such as plastic water, soft drink and juice bottles comprising a central body and an end-cap. In one preferred embodiment the central body comprises an affixing portion and a neck portion extending from the affixing portion, both portions having an internal and an external surface. The affixing portion is adapted to sealably affix the spout-cap onto a beverage bottle. Preferably, the affixing portion is internally threaded in order to engage the external threads of a common beverage bottle in order to sealably affixing the central body to the to the beverage bottle. The neck portion extending from the threaded portion terminates with at least one stopper. Furthermore, the neck portion of the central body is perforated, having at least one opening in proximity to, but not incorporating any part of, the stopper.

Therefore, if the central body is affixed to a beverage bottle in the absence of the end-cap, the liquid in the bottle would freely flow from the bottle, through the central body, exiting through the opening(s) located in proximity to the stopper that terminates the central body.

The end-cap comprises an engaging portion and a spout portion extending from the engaging portion whereby the spout portion terminates with an aperture. Preferably, the aperture comprises one or a plurality of perforations of very small diameter. Without being limited to any specific shape or contour, the external surface of the spout portion is preferably moulded to form a mouthpiece suitable for infants and small children. The end-cap is fitted over at least the neck portion of the central body whereby the engaging portion of the end-cap sealably engages said neck but may be slideably moved along said neck portion. Preferably, the engaging portion of the end-cap engages the neck portion of the central body by way of a notching mechanism in order to create specific, releasably fixed, positions for the end-cap along the neck of the central body. The notching mechanism may comprise one or a plurality of protrusions from the neck portion and one or a plurality of depressions in the engaging portion of the end-cap that are complementary in shape to the protrusions, or vice versa. The notching mechanism retains the end cap in one of the plurality of discrete positions, and also contributes to creating the liquid impermeable seal between the neck portion and the end-cap.

In a preferred embodiment the end-cap further comprises an internal sealing surface between the engaging portion and the aperture whereby a liquid impermeable seal is created between the sealing surface of the end-cap and the stopper of the neck portion of the central body. When the end-cap fully fitted onto the central body, said stopper of the central body contacts the sealing surface of the end-cap; therefore, achieving a closed configuration that prevents the flow of liquid between the aperture in the neck portion of the central body and the aperture in the spout portion of the end-cap. Movement of the end-cap away from the central body disengages said stopper from said sealing surface and enables the flow of liquid through neck portion of the central body and out through the aperture of the end cap; therefore, achieving an open position.

Some advantages of the present invention include the ability to tailor the size and shape of the spout for the intended user, obviating the need for a separate beverage container, the ability to replace by the original cap if desired and, the ability to construct spout-caps with various flow rates by varying the size and/or number of holes in the aperture. A further advantage is the ease of construction and assembly. The entire cap can be constructed of only two components, a central body and an end-cap, that are easily assembled into the functional spout-cap. Furthermore, by separating the sealing means from the flow regulating means, the spout-cap of the present invention may be manufactured to dispense liquid at a sufficiently low rate of flow for infants and children without any difficulty under current manufacturing tolerances. Both the central body and end-cap may be constructed of the same or different material; however, it is preferable that end-cap be constructed of a highly resilient polymer material.

### BRIEF DESCRIPTION OF THE DRAWINGS

In drawings which illustrate by way of example only a preferred embodiment of the invention,

FIG. 1A is a perspective view of the assembled cap of the present invention with the spout in the centered position;

FIG. 1B is a perspective view of the assembled cap of the present invention with the spout in the off-set position;

FIG. 1C is An exploded perspective view of the disassembled spout cap showing the exterior surface of the central body and the exterior surface of the end-cap.

FIG. 2A is an elevation of the cap shown in FIG. 1A;

FIG. 2B is a sectional elevation of the cap shown in FIG. 2A with the end-cap in the closed position;

FIG. 2C is a sectional elevation of the cap shown in FIG. 2A with the end-cap in the open position;

FIG. 3A is an elevation of the cap shown in FIG. 1a taken at 90 degrees from FIG. 2A;

FIG. 3B is a sectional elevation of the cap shown in FIG. 3A with the end-cap in the closed position;

FIG. 3C is a sectional elevation of the cap shown in FIG. 3A with the end-cap in the open position.

FIG. 4A is a sectional partial elevation of an alternate embodiment of the sealing means between the spout cap and the central body.

FIG. 4B is a sectional partial elevation of a further embodiment of the sealing means between the spout cap and central body.

FIG. 5 is an exploded perspective view of an alternate embodiment of a bottle cap of the present invention showing an alternate means for engaging the end-cap and central body.

### DETAILED DESCRIPTION OF THE INVENTION

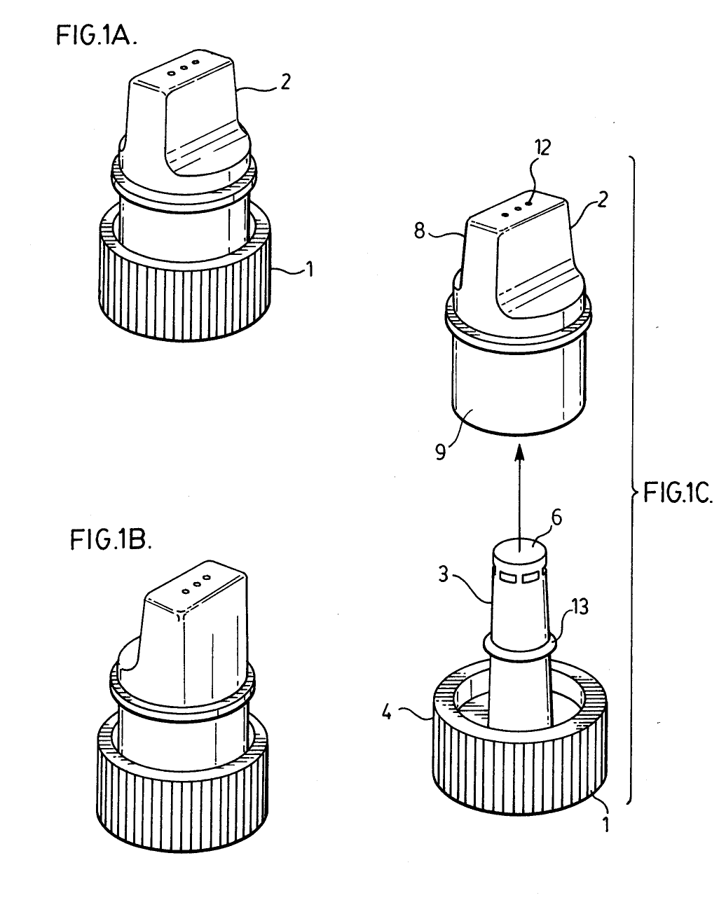

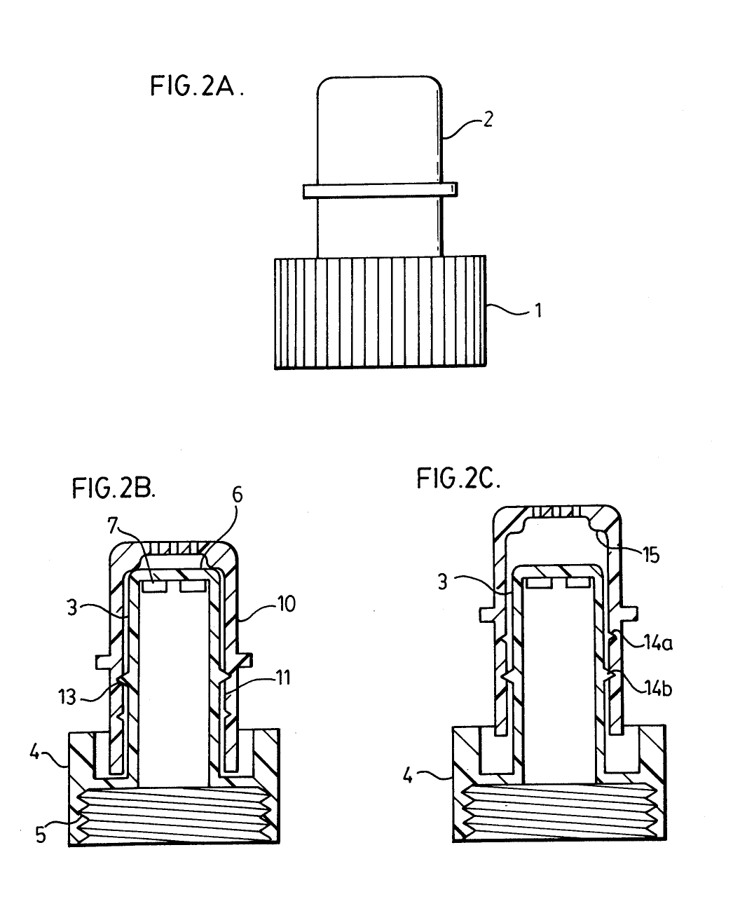

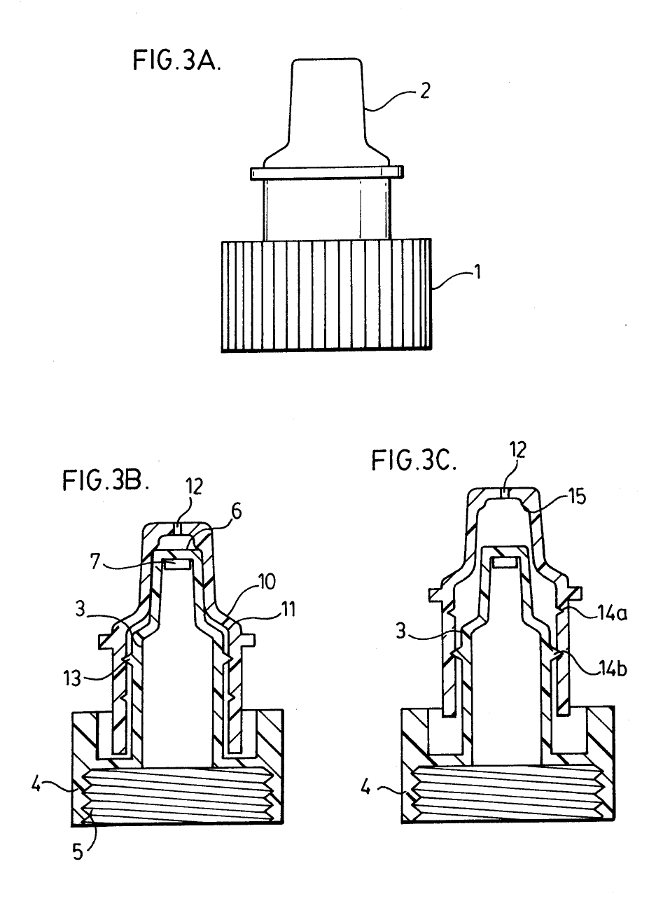

The spout-cap of the present invention is shown in FIGS. 1A to 1C and comprises a central body 1 and an end-cap 2. FIGS. 1A and 1B provide perspective views of the assembled spout-cap of the present invention and FIG. 1C shows the individual components of the spout-cap. FIGS. 2A and 3A provide further views of the assembled spout-cap of FIG. 1A. The central body 1 preferably comprises a threaded portion 3 and a neck portion 4, shown in FIG. 1C. The threaded portion 4, having an inside surface that is threaded 5, is adapted to be sealably affix the spout-cap onto a common beverage bottle having a threaded bottle neck, for example plastic beverage bottles such as those used for bottled water, soft-drinks and juices by engaging the threads of the bottle neck. The neck portion 3 extends from the threaded portion 4 and ends in a fluid-impermeable apex 6, serving as a stopper. The neck portion 3 is further perforated, preferably near the apex (without perforating the apex 6 itself) to create one or more openings 7 that permit the flow of liquid from the bottle through the central body 1 when it is affixed to a beverage bottle. Therefore, when the central body 1 is affixed to a beverage bottle, the liquid in the beverage bottle is free to flow through the neck portion 3 and out through the opening(s) 7 near the apex 6.

The end-cap 2 is generally elongate having a top 8 and a bottom 9, and comprises an outside surface 10 and an inside surface 11. The outside surface 10 of the top is shaped in the form of a spout having an aperture 12 comprising one or more perforations. The bottom 9 forms an engaging portion that is adapted to permit the end-cap 2 to be closely fitted over the neck portion 3 of the central body 1, as shown in FIGS. 2B and 2C. Therefore, the shape of the neck portion 3 of the central body 1 and the inside surface 11 of the end-cap 2 are generally complementary.

The end-cap 2 is thus complementary to the neck portion 3. Movement of the end-cap 2 along the neck portion 3 of the central body 1 is preferably regulated by a notching mechanism. For example, the inside surface 11 of the neck portion 3 has at least one protrusion 13, for example in the form of an annulus or concentric ring, and the end-cap 2 has two or more complementary depressions, for example an upper depression 14a and a lower depression 14b, in the present example being in the form of concentric depressions along inner surface 11 of the end-cap 2. Therefore, when the end-cap 2 is fitted over the central body 1, the end-cap 2 will reach a first position in which the protrusion 13 from the central body 1 engages the upper depression 14a as shown in FIG. 2C and FIG. 3C. Further movement of the end-cap 2 along the neck portion 3 of the central body 1 disengages the protrusion 13 from the upper depression 14a, until the protrusion 13 engages the lower depression 14b. The combination of the protrusion 13 and upper and lower depressions 14a, 14b enable a notching action to the movement of the end-cap 2 along the central body 1.

It will be appreciated that more than one releasably fixed position of the end cap 2 can be obtained by providing a commensurate number of depressions. It will also be appreciated that the protrusion 13 can take any form capable of lodging into the depression 14a, 14b in releasably fixed relation; that the protrusions can alternatively be on the neck 3 and the depressions on the end-cap 2; and/or that the notching mechanism can alternatively consist of a single depression and a plurality of protrusions, or a plurality of both depressions and protrusions, suitably spaced to releasable fix the end-cap 2 in the desired plurality of positions. The number and positions of the protrusion(s) and depression(s) control the releasably fixed positions of the end-cap 2, and as such can be selected to control the rate of flow of liquid through the spout-cap of the invention.

The inside surface 11 of the end-cap 2 further defines a sealing surface 15 that closes off communication between the aperture 12 in the top 8 and interior of the bottom 9. When the end-cap 2 is in the second position along the central body 1, that is, when the end-cap 2 fully fitted onto the central body 1, the apex 6 of the central body 1 contacts the sealing surface 15 of the end-cap 2. Therefore, when the end-cap 2 is in the second position, the spout-cap is in a closed configuration and liquid from the affixed bottle cannot flow from the opening(s) 7 in the apex 6 through the aperture 12 in the end-cap 2, as shown in FIG. 2B and FIG. 3B. Movement of the end-cap 2 from the second position to the first position, shown in FIG. 2C and 3C, moves the sealing surface 15 away from the apex 6 which enables the flow of liquid through opening(s) 7 in the neck portion 3 of the central body 1 and out through the aperture 12 of the end cap 2. In the first position, the spout-cap is therefore in an open configuration. By having the means for sealing the spout-cap separate from separate from the aperture, the present invention provides an advantage in that it allows for the construction of spout-caps with various flow rates by varying the size and/or number of holes in the aperture.

In order to avoid wear and tear damage to the central body 1 and end-cap 2 it is preferable that the components be constructed of the same material. It is also preferable that at least the end-cap 2 be constructed (for example molded) from a highly resilient and durable polymer in order to ensure that the effectiveness of the seal between the central body 1 and end-cap 2 does not diminish prematurely with regular use. Polypropylene is one example of such a resilient polymer; however, other appropriate resilient polymers would be known to a person skilled in the art.

Given the above description of the preferred embodiment, it would be apparent to a person skilled in the art that the invention is not limited to a spout-cap having a spout of a particular shape or contour nor is it limited to a spout aperture having the particular number, shape, arrangement or diameter depicted in the drawings. As shown in FIG. 1A, in the preferred embodiment, the spout is positioned along the vertical axis of the spout-cap, but embodiments in which the spout is off-set to one side relative to the vertical axis of the spout-cap are also possible.

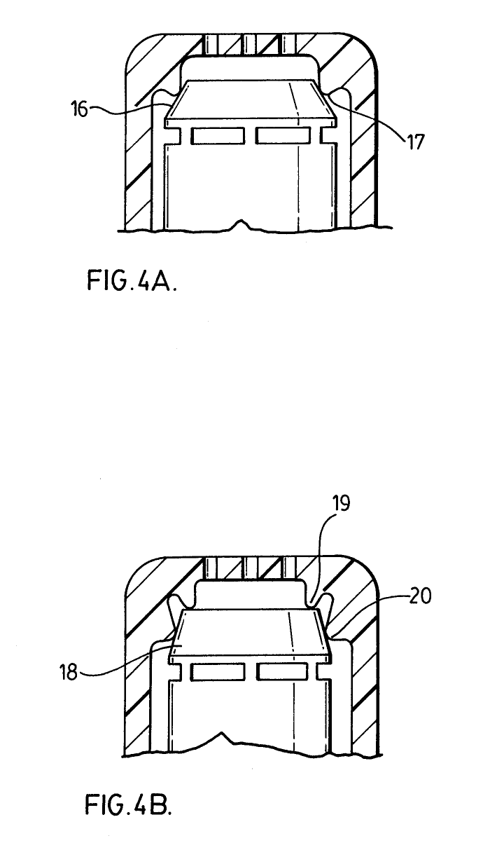

FIG. 4A depicts sealing surface and apex portions of the spout-cap of the present invention whereby the apex of the central body has a generally frusto-conical shape 16 with a flattened top surface and engages the downward protruding sealing surface 17 in a manner analogous to a stopper fitting into an aperture. FIG. 4B shows an example of a further embodiment in which the sealing surface engages the frusto-conical apex 18 on both the surface of the apex 19 and the sloping sides of the apex 20 in order to provide both a liquid impermeable barrier and additional gripping of the end-cap 2 onto the central body 1.

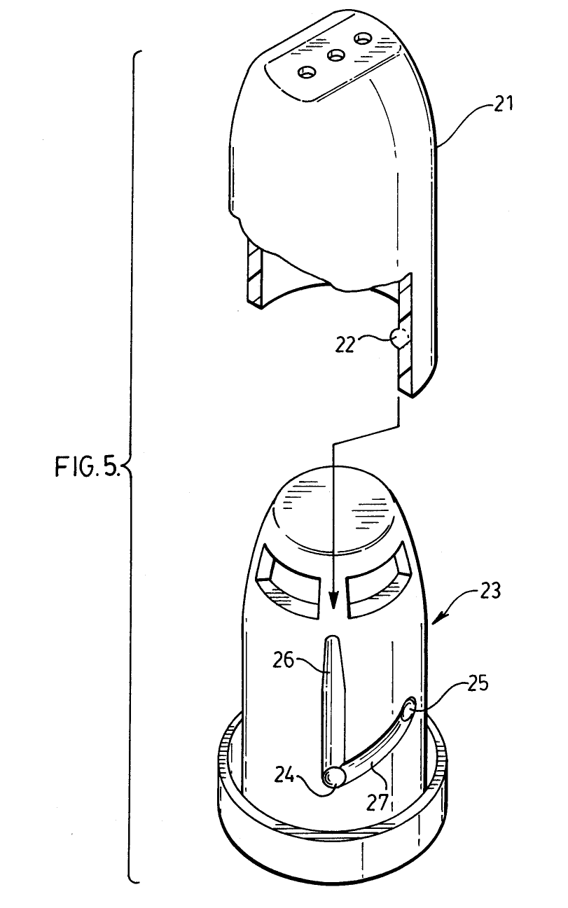

FIG. 5 shows an example of a further embodiment in which the spout-cap is moved from a closed condition to an open condition by means of a twist-open mechanism that further enables the end-cap 21 to be removed from the central body 28. In the example shown in FIG. 5, the end-cap 21 has a hemispherical protrusion 22 on its inside surface, and the central body 23 has a first hemispherical depression 24 connected to a second hemispherical depression 25 via a slanted or helical channel 27. A vertical channel 26 extending from the first hemispherical depression 24 up the neck 3 allows the end cap 21 to be engaged to the central body 28. As in the previous embodiments, the end-cap 21 is adapted to fit closely over the central body 22, with the hemispherical protrusion 22 moving within the vertical channel 26 until the end-cap 21 reaches a first position in which the protrusion 22 engages the first depression 24. The end-cap 21 can then be twisted, thereby moving the protrusion 22 from the first depression 24 within the channel 27 into a second position in which it engages the second depression 25. By twisting the end-cap 21 from the second position to the first position, the spout-cap is adjusted from an open to a closed configuration as the hemispherical projection rides along the slanted channel 27.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A bottle cap, comprising:
a central body for attachment to a bottle, comprising a neck in fluid communication with the bottle when attached to the bottle, the neck comprising at least one opening through the neck and terminating in a fluid-impermeable apex,
an end-cap having a spout comprising a portion engaging over the neck and a sealing surface for engagement with the apex of the neck when the bottle cap is in a closed condition, the sealing surface being between the portion engaging over the neck and an aperture for dispensing fluid from the bottle, and
a notching mechanism, comprising
at least one protrusion extending from one of the central body and the end-cap and a plurality of depressions complementary to the protrusion formed in the other of the central body and the end-cap, or
at plurality of protrusions extending from one of the central body and the end-cap and at least one depression complementary to the protrusions formed in the other of the central body and the end-cap,
whereby the end-cap can be releasably fixed to the closed position in which the sealing surface is engaged with the apex of the neck, and releasably fixed in at least one open postion in which the sealing surface is spaced from the apex of the neck and the aperture in the spout is in fluid communication with the bottle through the neck.
